(19) United States
(12) Patent Application Publication
(10) Pub. No.: US 2013/0092467 A1
(43) Pub. Date: Apr. 18, 2013

(54) Electronic Front Wheel Traction Assist for General Purpose and Task Oriented Vehicles

(71) Applicant: Bill Jager, Waterloo (CA)

(72) Inventor: Bill Jager, Waterloo (CA)

(21) Appl. No.: 13/653,889

(22) Filed: Oct. 17, 2012

Related U.S. Application Data
(60) Provisional application No. 61/548,519, filed on Oct. 18, 2011.

(51) Int. Cl. B60K 6/485; B60K 6/52

(52) U.S. Cl. CPC B60K 6/485; B60K 6/52; Y10S 903/951
USPC 180/243; 180/242; 180/65.26; 903/951

(57) ABSTRACT

A vehicle with electric wheel hub motors for one or more wheels for operation to provide drive at low vehicle speeds and to supplement one or more primary drive motors which drive other wheels of the vehicle through all desired vehicle speeds including the low vehicle speeds and vehicle speeds higher than the low speeds.

### RELATED APPLICATION

This application claims the benefit under 35 U.S.C. 119(e) to U.S. provisional patent application Ser. No. 61/548,519 filed Oct. 18, 2011.

### SCOPE OF THE INVENTION

The present invention describes an Electric Traction Assist mechanism for vehicles.

The invention more particularly relates to an electrical mechanical system that delivers maximum torque to selected wheels of a vehicle when it is required the most for acceleration or enhanced traction.

### BACKGROUND OF THE INVENTION

Wheel motors are commonly used in electric bicycles, wheel chairs and other task oriented vehicles.

This invention applies mainly to vehicles which are primarily battery powered and to hybrid vehicles with significant availability of electric power.

Battery powered electric vehicles such as golf carts and tow motors are well established in the marketplace. Motors designed for these vehicles typically represent a compromise between the competing design parameters of speed, torque and weight.

Many of these rear wheel drive vehicles use a single electric motor in conjunction with a transaxle to drive the rear wheels without driving the front wheels. If four wheel drive is required in such rear wheel drive vehicles, a second transaxle is normally added to the vehicle to drive the front wheels. This arrangement adds significant weight to the vehicle and complexity to the steering and suspension design. Many other vehicles have front wheel drive with the front wheels powered as by an internal combustion or electric engine to drive the vehicle without driving the rear wheels. One strategy to achieve four wheel drive is to have wheel motors for all wheels of a vehicle. This can have minimal impact on the vehicle's steering, suspension and weight. However, a major drawback is that such electric motors have RPM to match the highest speed of the vehicle. This would lead to large expensive motors as they would also need to provide high starting torques.

However, the present inventor has appreciated that disadvantages arise in the use of electric motors with wheel motors with design RPM to match the highest speed of the vehicle. When an electric motor is driven beyond its design speed, it becomes a generator and complicated control strategies such as field weakening or WYE-Delta switching are required to increase the speed of the motor.

The current invention teaches a low cost alternative which allows a relatively small inexpensive motor to provide significant traction assistance at a time when it is most desirable.

In vehicular applications, it is desirable to have maximum torque available at low RPMs for purposes of work, traction or maximum acceleration. It is also desirable to have maximum speed available to minimize transit time. To achieve both of these objectives, known vehicles utilize multi-speed mechanical gear boxes or alternatively employ a field weakening strategy to increase the top speed of a motor designed primarily to deliver high torque. This approach results in additional weight, mechanical complexity and reduced motor efficiency in the case of field weakening.

In the case of battery powered vehicles, it is also desirable to achieve maximum efficiency under all circumstances which ensures that the vehicle will attain its greatest possible range or work output. This is the overriding design constraint for electric vehicles. Such vehicles require a high overall operating efficiency since they are battery operated and must carry all of their energy with them in the form of heavy batteries.

For a given motor, when maximum torque is required, it will operate most efficiently in wye configuration and, alternatively, when maximum speed is required, it will operate most efficiently in delta configuration.

Poor performance has been the principle disadvantage of battery powered electric vehicles. For obvious reasons, it is highly desirable for the drive systems of electric vehicles to be able to provide maximum Torque or maximum Speed when required and to do so in a way that maximizes the overall system efficiency.

Electric utility vehicles in particular have enjoyed limited market acceptance because they are impractical for many potential desirable applications. When they are designed to work, they must be efficient at low speeds in order to meet expectations. However, transporting a low speed work vehicle and its operator from point to point is a cumbersome and time consuming task. A vehicle which would be able to efficiently perform low speed tasks such as mowing lawns, blowing snow or climbing hills while retaining the ability to travel at 25 mph as a LSV (Federally Mandated in the United States) would be much more practical than currently available drive systems. The present invention describes an electric drive system that can be optimized for both high and low speed operation.

### SUMMARY OF THE INVENTION

To at least partially overcome some of the disadvantages of previously known electric vehicles, the present invention provides a vehicle with electric wheel hub motors for one or more wheels for operation to provide drive at low vehicle speeds and to supplement one or more primary drive motors which drive other wheels of the vehicle through all desired vehicle speeds including the low vehicle speeds and vehicle speeds higher than the low speeds.

The present invention provides a vehicle with additional torque at low speeds when it is most needed for traction, work or acceleration. This is done without incurring significant weight penalties or adding unnecessary complexity to the vehicle or it's control systems.

For the present invention, preferred embodiments include supplementing wheel/hub motors for one of the front and the rear of the vehicle and any of the current primary wheel drive strategies at the other of the front and the rear. This invention will significantly enhance the performance of conventional vehicles with either electric or IC powered rear wheel drive.

For a given size (wattage of motor) the power output is a linear function of the product of torque and speed. Simply put, an electric motor with a design speed of 100 RPM might produce a starting torque of 300 Nm. That same motor if it were wound to go 300 RPM would produce torque of approximately 100 Nm.

Utilizing the current invention, when the vehicle starts to accelerate, the supplementing wheel/hub motors are providing maximum torque until the vehicle achieves a predetermined cut-out speed. At this point, the supplementing motors have achieved their design speed and the primary drive motor thereafter provides drive alone at higher speeds.

The supplementing motors are equipped with a one-way over-running clutch. When the vehicle starts to move faster than maximum design speed that the supplementing motor would normally allow, the clutch mechanically disconnects the supplementing motor from the system and, optionally, a controller reduces or disconnects the power being delivered to the supplementing motor. At this point and at speeds higher than the supplementing motor's design speed, the primary motor driving the other wheels provide all of the traction power to the vehicle and the supplementing motors are mechanically and preferably electrically disconnected from the vehicle drive system.

Conversely, when the vehicle slows down to a speed less than the supplementing motor's design speed, the clutch mechanically connects the supplementing motors to the system, the supplementing motors will provide full torque to the supplementing wheels of the vehicle, of course with the controller again delivering power to the supplementing motors if the power to the front motors had been reduced or disconnected.

Differentiation for steering preferably can be implemented as is common in the art but is not necessary. The side to side power split will be a function of steering angle.

The invention is advantageous for an arrangement in which the supplementing motors drive the vehicle's front wheel or wheels and a primary motor or motors drives the rear wheel or wheels as in a conventional rear wheel drive vehicle with supplementing wheel/hub motors provided on each front wheel. The invention is also advantageous for an arrangement in which the supplementing motors drive the vehicle's rear wheel or wheels and a primary motor or motors drives the front wheel or wheels such as in a front wheel drive electric, hybrid or IC motor of automobiles. The invention is applicable to bicycles, tricycles, four wheeled vehicles and other multi-wheeled vehicles.

In the case of a six (or more) wheeled vehicles, the wheels located behind the driver can be treated as the rear wheels and the wheels in front of the driver or the steering wheels will be considered to be the front wheels. The drive strategy will be the same as above. The invention is applicable to vehicles which have any maximum vehicle speed whether, for example, 25 mph or greater, say, 80 mph.

### METHOD OF OPERATION

A method of operation of the invention is now described with reference to an embodiment in which the primary motors drive the rear wheels and supplementing hub motors drive the front wheels. Each of the front wheels is preferably driven by an independent electric motor which has a built-in one-way clutch that allows their output shaft to spin much faster than the design speed of the motor when the vehicle needs to travel at a speed greater than that would be allowed by that motor if it were directly coupled to the drive train. The rear wheels can be driven by any conventional method including but not limited to electric transaxles, IC engines or independent wheel motors. The electric front motors are designed to operate at much lower RPMs than the maximum speed of the vehicle. This is done to increase the low-speed torque availability from the front motors. This strategy is suitable for any vehicle application requiring additional traction, acceleration or ability to do work at low speeds. For high-speed operation of the vehicle the front motors are mechanically de-coupled from the drive system through the use of a one-way clutch and optionally the electrical power to these motors can be reduced or entirely cut off.

### BRIEF DESCRIPTION OF THE DRAWINGS

Further aspects and advantages of the present invention will become apparent from the following description taken together with the accompanying drawings in which:

FIG. 1 is a perspective view of a vehicle in accordance with the first embodiment of the present invention;

FIG. 2 is a bottom view of the vehicle of FIG. 1 showing the tires as removed from three of the wheels;

FIG. 3 is a vertical cross-sectional view through the right-hand-most rear wheel shown in FIG. 1;

FIG. 4 is a vertical cross-sectional view the same as FIG. 3 but through the right-hand-most front wheel shown in FIG. 1;

FIG. 5 is a vertical cross-sectional view through the overrunning clutch shown in FIG. 4;

FIG. 6 is a pictorial view of a schematic control diagram for the vehicle of FIG. 1.

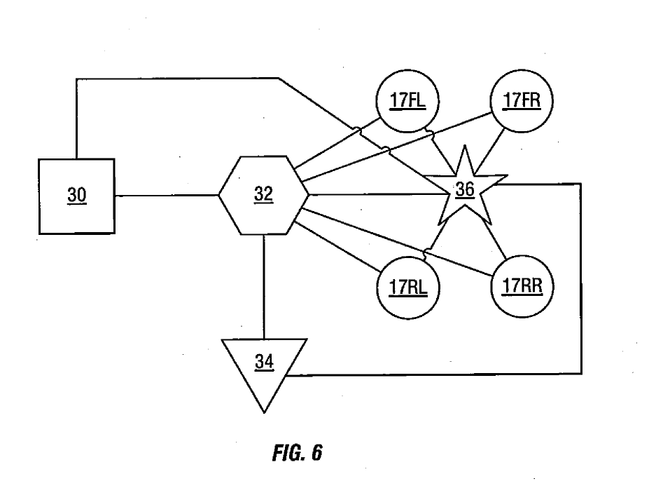

### DETAILED DESCRIPTION OF THE DRAWINGS

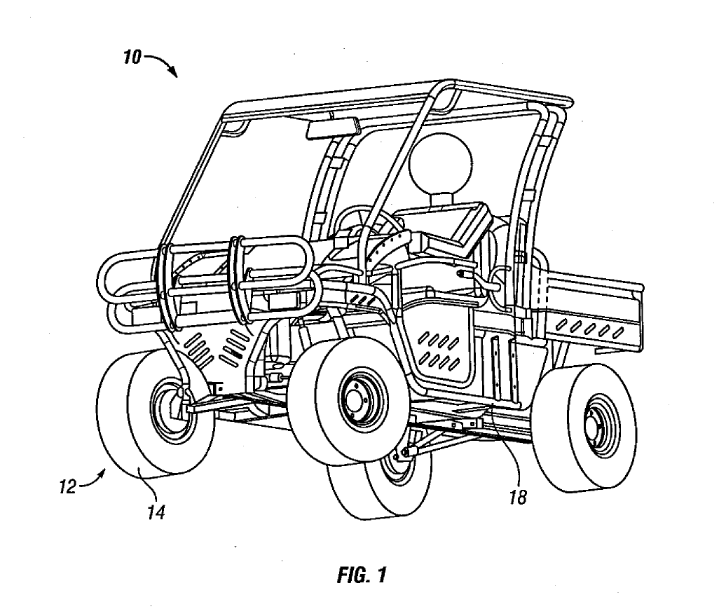

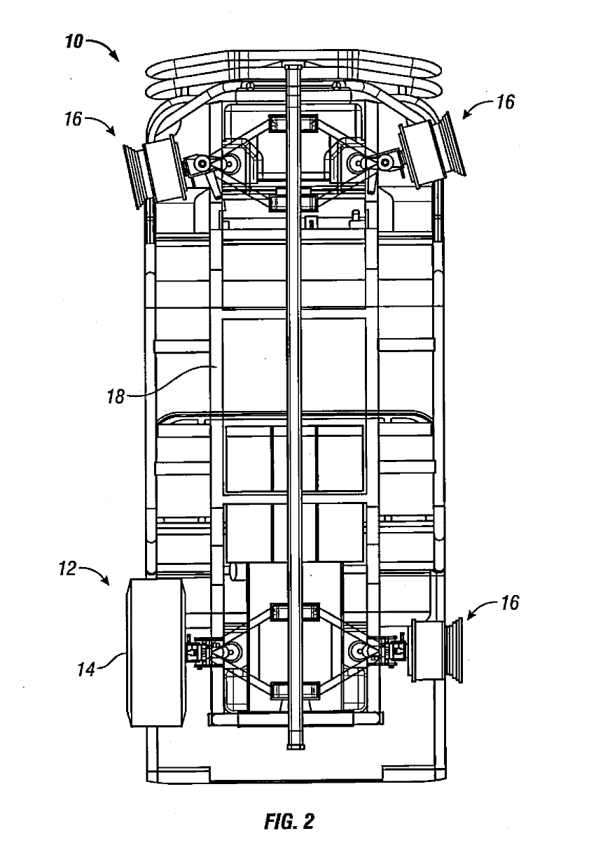

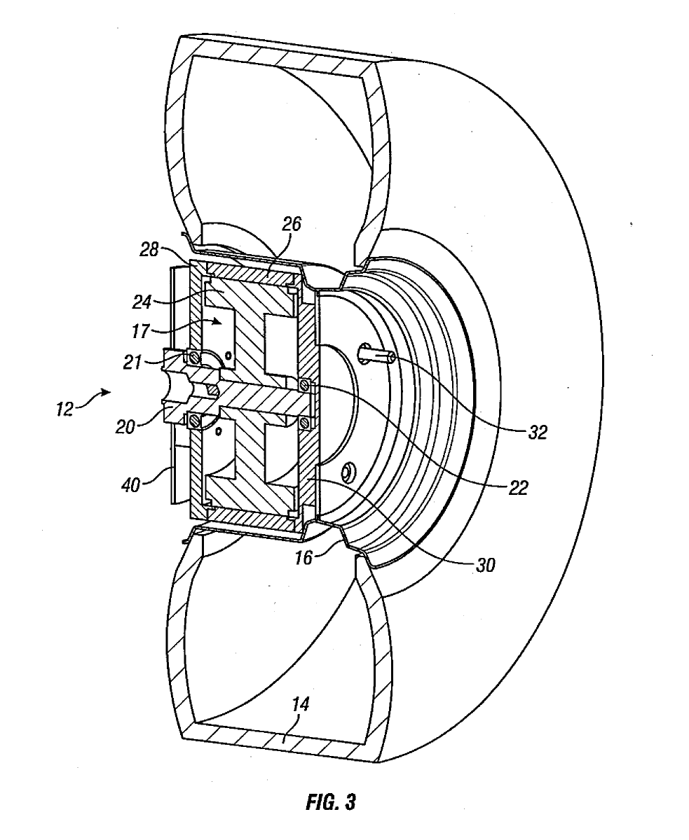

Reference is made to FIG. 1 which shows a perspective view of a battery powered electric vehicle 10 in accordance with the first embodiment of the present invention and having four ground engaging wheels 12, each of which is substantially identical and has a construction as best seen in FIG. 3. Each wheel 12 comprises a tire 14 mounted on a deep-dish wheel hub 16 which wheel hubs 16 are best seen in FIG. 2 on which the tires 14 have been removed from three of the wheels. As seen in FIG. 2, each of the wheels is suitably mounted to a frame generally indicated as 18 for the vehicle 10 with the front wheels 12 suitably mounted for steering.

As best seen in FIG. 3, the rear wheel 12 includes a shaft 20 fixed against rotation to the frame of the vehicle schematically shown as frame plate 40 in FIG. 3. A stator 24 is fixedly mounted coaxially about the shaft 20. A rotor 42 is provided for rotation coaxially about the shaft 20 on suitable bearings 21 and 22. The rotor 42 comprises an inside hub 28 and an outside hub 30 fixedly joined together by a magnet stack 26 coaxially outwardly about the shaft 20 between the inside hub 28 and the outside hub 30. The deep-dish wheel 16 is mounted to the outside hub 30 as schematically shown by a bolt 32. An electric motor 17 is thus provided in each wheel 12 which provides a direct drive to its respective wheel 14.

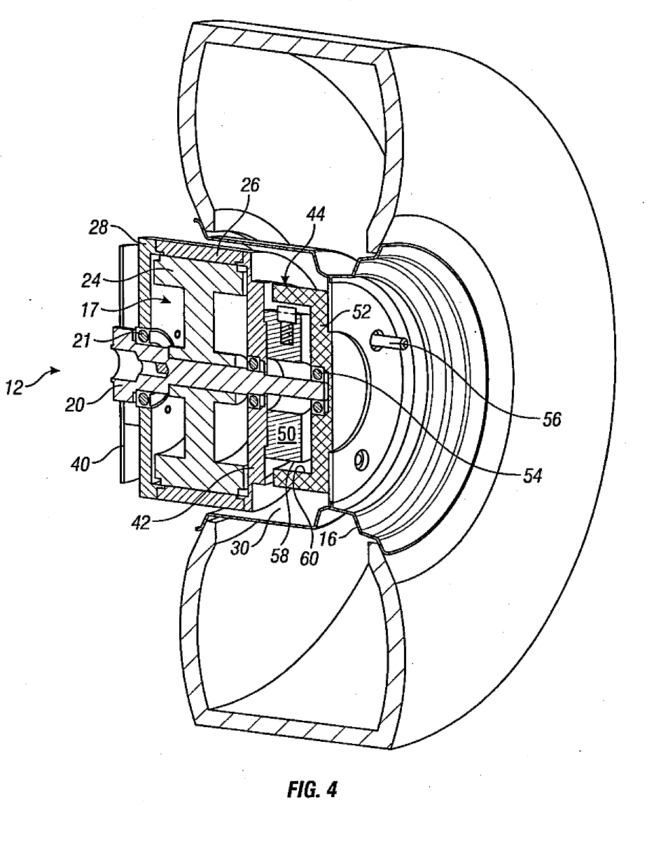

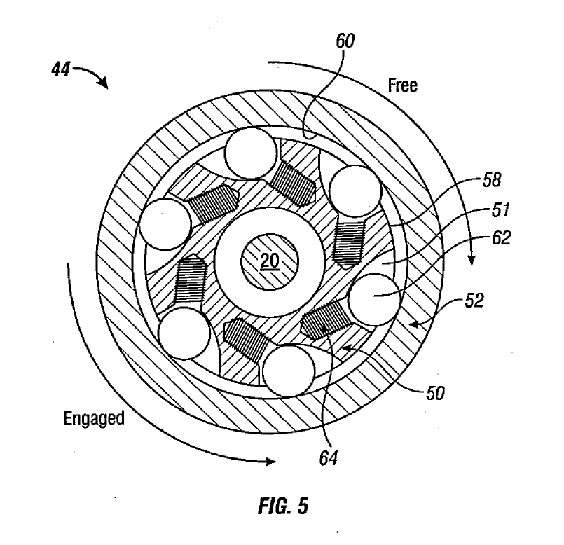

Reference is made to FIG. 4, which shows a cross-sectional view normal to the axis of the shaft of a front wheel 12. The front wheel 12 of FIG. 4 is identical to the rear wheel 12 of FIG. 3 but for the addition of a freewheel or overrunning clutch 44 disposed between the rotor 42 and the hub 28. The clutch 44 disengages the hub 28 from the rotor 42 when the hub 28 rotates faster than the rotor 42. As seen in FIG. 5 a drive disc 50 is provided fixedly coupled to the rotor 42. A driven cylinder 52 is journalled for rotation about the shaft 20 on bearings 54. The hub 28 is fixedly mounted to the driven cylinder 52 by bolts 56. The drive disc 50 has a radially outwardly directed surface 58 in opposition to a radially inwardly directed surface 60 on the driven cylinder 52. As best seen in FIG. 5, the drive disc 50 has a plurality of recesses 51 in its radially outwardly directed surface 58, each adapted to receive and retain therein a steel roller 62 and a spring 64 such that each steel roller 62 which is biased radially outwardly by its spring 64 towards engagement with the radially inwardly directed surface 60 on the driven cylinder 52. Each roller 62 is disposed in its recess 51 for rotation about an axis parallel to the axis of the shaft 20. Each roller 62 is biased radially outwardly by its spring 64 at an angle to a radius from the axis of the shaft 20. On rotating the rotor 42 and its drive disc 50 counter-clockwise as shown in FIG. 5 relative to the driven cylinder 52, the rollers 62 engage the radially inwardly directed surface 60 on the driven cylinder 52 and lock the drive disc 50 to the driven cylinder 52 such that they rotate in unison. On rotating the rotor 42 and its drive disc 50 counter-clockwise as shown in FIG. 5 relative to the driven cylinder 52, the rollers 62 slip on the radially inwardly directed surface 60 on the driven cylinder 52 such that the driven cylinder 52 is disengaged from the drive disc 50.

Each electric motor 17 is a 3-phase magnetic motor of the type. Each motor may be energized in a delta configuration or in a wye configuration, or possibly capable of being energized selectively in a delta configuration and in a wye configuration. Each motor is preferably a brushless motor.

Reference is made to FIG. 5 which shows a control diagram for the vehicle of FIG. 1. In FIG. 4, electric motors for each of the respective wheels are indicated as a separate motor 17 with a designated 17FR for the front right, 17FL for the front left, 17RR for the rear right and 17RL for the rear left. The diagram shows a battery 30 as a power source, a controller 32, a steering wheel 34 and sensors 36. Each of the battery, steering wheel, sensors and motors are shown as connected to the controller 32 for control by the same.

The controller 32 is capable of controlling the relative power applied to the motor for each wheel and, as well, to prevent any power from being provided to the motor for any wheel such that that wheel may be free to rotate. The sensors 36 represent various sensors which are provided to sense information from the wheels, steering wheel and the battery, for example, to indicate the speed of the vehicle at any time, permitting the controller to determine acceleration or deceleration. The sensors can sense the battery level, the power being supplied to or from each electric motor measured by the current and/or voltage. The sensors 36 provide various information and can be useful for the controller 32 to control the relative operation of the motors for each wheel as, for example, to select the power to be provided.

In operation, the controller senses the vehicle speed. Preferably at all times when the vehicle is powered to move forwardly, the controller provides suitably selected power to the rear wheel motors 17RR and 17RL. When the vehicle speed is less than a design speed for the front wheel motors 17FR and 17FL, the controller provides power to the front wheel motors 17FR and 17FL to supplement the drive provided by the rear wheel motors. When the vehicle speed is equal to or greater than the design speed for the front wheel motors 17FR and 17FL, the controller reduces the power to the front wheel motors 17FR and 17FL, preferably providing no power to the front wheel motors 17FR and 17FL, such that drive at vehicle speeds above the design speed for the front wheel motors is provided merely by the rear wheel motors. Preferably, the design speed for the front wheel motors is about 30% of a preselected maximum vehicle speed.

In the preferred embodiment as a clutch mechanism, one example of a mechanical freewheel or overrunning clutch is shown. Various other clutch type coupling devises may be used, whether mechanically, hydraulically or electronically activated. For example, as mechanical devices, other one-way freewheel clutches may be used, such as one of a Sprag clutch, a retching freewheel mechanism with pawls and spring loaded, saw-toothed discs pressing against each other with the toothed sides together.

In a preferred embodiment, each of the motors for the rear wheels is capable of being configured either in a wye configuration or a delta configuration as can be advantageous to optimize the torque provided to the rear wheels as a function of speed. This is not necessary however. The controller 32 has a capability of configuring each rear wheel motor 17RR and 17RL to either be in the wye configuration or the delta configuration preferably by the controller controlling suitable switches which switches preferably can place each motor either in the wye configuration or the delta configuration or a configuration in which power is not provided.

The invention is particularly adaptable to retrofitting existing four wheeled electric motor or gas motor golf carts or other task oriented vehicles which have an electric or a gas motor driving the rear wheels. In the retrofit, a hub wheel motor is provided for each front wheel and a suitable controller and possibly a battery is provided. At relatively low cost, the rear wheeled vehicle can be converted to a vehicle with four wheel drive at low speeds. The hub wheel motor for the front wheels in having but a low maximum design speed permitting them to have a small size combatable with mounting as hub wheel motor on the front wheels.

A preferred embodiment has been described with reference to the Figures with the front wheels being driven by the supplementing motors and the rear wheels driven by the primary motors. An alternate embodiment in the Figures is with the rear wheels being driven by the supplementing motors and the front wheels by the primary motors.

While the invention has been described with reference to preferred embodiments, many modifications and variations will now occur to a person skilled in the art. For a definition of the invention, reference is made to the following claims.

I claim:

1. A vehicle having at least two ground engaging wheels comprising one forward wheel and one rear wheel,
an independent electric motor for each respective front wheel to independently drive each respective front wheel,
a respective overrunning clutch disposed between each electric motor and each respective front wheel,
each overrunning clutch engaging the wheel with the motor when the wheel rotates slower than the motor,
each overrunning clutch disengaging the wheel from the motor when the wheel rotates faster than the motor,
an electrical battery serving as a power source for the electric motors,
a controller for controlling the supply of power to each electric motor,
a drive system to drive the rear wheels throughout a range of speeds of the vehicle from a zero vehicle speed to a maximum vehicle speed,
each electric motor having a maximum design speed of rotation,
at the design speed of each electric motor, the electric motor rotating the front wheel at a speed which corresponding to a low vehicle speed which is less than the maximum vehicle speed.

2. A vehicle as claimed in claim 1 wherein the maximum vehicle speed is pre-selected and the low vehicle speed is in the range of 30% of the maximum vehicle speed.

3. A vehicle as claimed in claim 1 wherein when the vehicle speed exceeds the low vehicle speed, the controller reduces power to the electric motors.

4. A vehicle as claimed in claim 1 wherein an internal combustion engine drives the rear wheels.

5. A vehicle having at least two ground engaging wheels comprising one forward wheel and one rear wheel,
an independent electric motor for each respective rear wheel to independently drive each respective rear wheel,
a respective overrunning clutch disposed between each electric motor and each respective rear wheel,
each overrunning clutch engaging the wheel with the motor when the wheel rotates slower than the motor,
each overrunning clutch disengaging the wheel from the motor when the wheel rotates faster than the motor,
an electrical battery serving as a power source for the electric motors,
a controller for controlling the supply of power to each electric motor,
a drive system to drive the front wheels throughout a range of speeds of the vehicle from a zero vehicle speed to a maximum vehicle speed,
each electric motor having a maximum design speed of rotation,
at the design speed of each electric motor, the electric motor rotating the front wheel at a speed which corresponding to a low vehicle speed which is less than the maximum vehicle speed.

6. A vehicle as claimed in claim 5 wherein an internal combustion engine drives the front wheels.
